(19) United States
(12) Patent Application Publication
(10) Pub. No.: US 2017/0367381 A1
(43) Pub. Date: Dec. 28, 2017

(54) IN-BAG PROCESS FOR COOKING OR PARTIALLY COOKING WATER-ABSORBING AND OTHER FOOD PRODUCTS IN A CONTINUOUS OVEN

(71) Applicant: David Howard, Bristow, OK (US)

(72) Inventor: David Howard, Bristow, OK (US)

(21) Appl. No.: 15/194,811

(22) Filed: Jun. 28, 2016

(51) Int. Cl. A23L 5/10; B65D 81/34; A23L 7/10

(52) U.S. Cl. CPC A23L 5/13; A23L 7/1975; B65D 81/343; A23V 2002/00; B65D 2581/3422; B65D 2581/3427; B65D 2581/3404

(57) ABSTRACT

A process for cooking rice, quinoa, couscous, pasta, beans, chick peas and other products which absorb water during the cooking process. The product is placed in sealed cooking bags along with a sufficient amount of liquid for absorption. The sealed bags are then conveyed through a continuous oven in which they are contacted with a superheated vapor cooking medium.

### FIELD OF THE INVENTION

The present invention relates to systems and methods for fully cooking or partially cooking products, such as rice, quinoa, couscous, pasta, beans, chick peas, or pinto beans, as well as other grains, legumes, or similar products, which absorb water, other cooking liquids or steam during cooking. The present invention also relates to systems and methods for fully cooking or partially cooking root vegetables such as potatoes and carrots.

### BACKGROUND OF THE INVENTION

There is currently great growth in the demand for pre-cooked foods and prepared meals. However, one area in which it has been particularly difficult to achieve consistent product quality has been the cooking of grains or particulate grain products (e.g., rice, quinoa, or couscous) which absorb significant quantities of water during the cooking process.

In addition, the cooking of these products is further complicated by the fact that the culinary requirements for the cooked product will vary significantly from recipe to recipe, from chef to chef, and/or from region to region around the globe. For example, in Japan, rice is cooked to a consistency known as “sticky rice” which aids in the forming of Sushi rolls or the use of chopsticks. However, in India, it is typically preferred in preparing Basmati rice and Jasmine rice that the rice not have a sticky consistency but that the individual cooked grains have more of a fluffy and separable nature.

Typically, precooked rice for sale or for use in other precooked dishes, entrees or meals has been prepared in large batch kettles which cook from about 100 to about 1,000 pounds of rice at a time. Frequently the actual cook time and consistency of the cooked product can vary significantly depending upon such factors as the ability of the operator to unload the kettle at a specific time. If, for example, more than one kettle must be unloaded by an operator at the same scheduled time or at close to the same scheduled time, there can be a variance in the actual cooking time and the resulting characteristics of the finished products.

Another deficiency of the prior kettle methods for cooking rice and other grains has been the loss of nutrients. Typically, water is added to the kettle and brought to a boil. The grain is then added and the mixture is simmered for a given time. However, when the grain is dropped into boiling water, certain nutrients “flash off” and are lost to the atmosphere.

Rice and pasta have also been directly cooked in hot water using continuous water cooking systems. However, in these continuous water cookers, in addition to the same or greater loss of nutrients from the rice or pasta as discussed above, water is continuously exhausted from the cooker in the form of steam which carries the nutrients from the rice or pasta into the atmosphere. These nutrients can provide a food source for the growth of pathogens such as Listeria monocytogenes. Furthermore, after each cooking shift, it is not unusual that up to 500 gallons or more of cooking by-product water must be disposed of as waste water for treatment.

In addition, the procedures required for transfer, handling, cooling, and storing grains and other products cooked in bulk in kettles and in continuous water cookers have presented cross-contamination problems and have been very time consuming, costly and inefficient. The state of the art today is that a bulk cooked rice product will typically be loaded into an industry standard 200 liter Euro bin for cooling and storage. Cooling the cooked rice in the Euro bin to a temperature of 4° C. requires approximately 4 hours. Moreover, during the transfer, handling and loading of the bulk cooked product, the product is exposed to the environment, in which it can become cross-contaminated. Also, the bulk chilling of the product leads to the growth of Bacillus cereus, particularly in rice.

### SUMMARY OF THE INVENTION

The present invention satisfies the needs and alleviates the problems discussed above. In one aspect, there is provided a method of at least partially cooking a product which absorbs water when cooked, wherein the product is selected from rice, quinoa, other water-absorbing grains, couscous, pasta, pinto beans, chickpeas, or other water-absorbing legumes. The method preferably comprises the steps of: (a) placing an amount of the product and an amount of liquid in each of a plurality of bags, the liquid being water, other cooking liquid, or a combination thereof; (b) sealing the bags; (c) placing the sealed bags on a conveyor which conveys the sealed bags through a continuous oven; and (d) at least partially cooking the product in the continuous oven by contacting the sealed bags with a cooking medium in the continuous oven.

In another aspect, the method preferably comprises the steps of: (a) placing an amount of the product and an amount of the liquid in each of a plurality of bags; (b) sealing the bags; (c) placing the sealed bags on a conveyor which conveys the sealed bags upwardly or downwardly in a spiral pattern in a continuous spiral oven; (d) at least partially cooking the product in the continuous spiral oven by contacting the sealed bags with a vapor cooking medium in the continuous spiral oven, the vapor cooking medium comprising at least 30% by volume superheated steam; and (e) maintaining the vapor cooking medium in the continuous spiral oven in step (d) at a temperature of greater than 212° F. by adding superheated steam to the vapor cooking medium and heating the vapor cooking medium using one or more heating elements.

In other aspects, the method can be characterized in that:
the amount of liquid placed in the bags is preferably in the range of from about 80% to about 300% by weight of the amount of the product placed in the bags;
at least 70% of the amount of liquid placed in the bags is absorbed in step (d) by the product;
prior to step (a), the liquid is preferably equilibrated at a temperature in the range of from about 40° F. to about 50° F.;
the method can further include the step, after step (d), of cooling the at least partially cooked product by contacting the sealed bags with a cooling medium;
prior to filling, the size of each bag is preferably at least 15 cm×15 cm (standard bag sizes are 8″×12″, 8″×15″, 10″×12″, 12″×14″, 12″×18″, and 16″×24″) and, when filled and placed on the conveyor, each bag has a maximum vertical thickness of not more than 6 cm;
the method can further comprise the step of shipping the at least partially cooked product to another location in the sealed bags; and/or
the method can further comprise the step of providing the at least partially cooked product to consumers or food service users in the sealed bags.

The inventive in-bag, continuous oven process for cooking grains, pasta, and other water-absorbing products ensures the that the ingredients, cooking temperatures, cooking times and other conditions used in the cooking process are always the same for each bag. Therefore, the resulting bag-cooked products are always perfectly prepared and entirely uniform. Additionally, all or substantially all of the water and/or other liquid placed in the cooking bags can be absorbed during the inventive cooking process so that no excess liquid must be drained and disposed of or treated.

The inventive in-bag, continuous oven cooking process also: prevents the loss of nutrients due to nutrient flashing; prevents the release of nutrient laden steam into the cooking facility which can promote the growth of pathogens and also creates a less desirable working environment; allows the cooking process to be conducted in a continuous manner; allows the cooked product to be chilled in the sealed cooking bags which reduces the time required to cool the product to 4° C. to less than an hour; and greatly increases food safety and the shelf life of the product by allowing the sterile cooked product to remain in the sealed cooking bag during handling, transfer, chilling, storage, shipping, and/or even up to an ultimate use of the product by consumers or food services.

In another aspect, there is provided a method of at least partially cooking a product selected from potatoes, carrots, other root vegetables, or a combination thereof. The method preferably comprises the steps of (a) placing an amount of the product and an amount of liquid in each of a plurality of bags, the liquid being water, other cooking liquid or a combination thereof; (b) sealing the bags; (c) placing the sealed bags on a conveyor which conveys the sealed bags through the continuous oven; and (d) at least partially cooking the product in the continuous oven by contacting the sealed bags with a cooking medium in the continuous oven.

Further aspects, features, and advantages of the present invention will be apparent to those in the art upon reading the following Detailed Description of the Preferred Embodiments.

### DETAILED DESCRIPTION OF THE PREFERRED EMBODIMENTS

As noted above, the inventive in-bag, continuous oven process for cooking water-absorbing products preferably comprises the steps of: (a) placing an amount of the product and an amount of liquid in each of a plurality of bags, the liquid being water, other cooking liquid, or a combination thereof; (b) sealing the bags; (c) placing the sealed bags on a conveyor which conveys the sealed bags through a continuous oven; and (d) at least partially cooking the product in the continuous oven by contacting the sealed bags with a cooking medium in the continuous oven.

The water-absorbing food product cooked in accordance with the inventive method can be generally any food product, preferably in the form of grains or other individual pieces, which absorbs water, or other liquid in which the product is cooked, during the cooking process. Examples of such water-absorbing food products include, but are not limited to: rice, quinoa, or other water-absorbing grains; couscous or other water-absorbing granular products; macaroni, pasta shells, or other pasta products; and dried beans, pinto beans, chickpeas, or other water-absorbing legumes.

It will be understood, however, that the inventive in-bag, continuous oven process can also be used for cooking potatoes, carrots, other root vegetables, or combinations thereof. Although the inventive process is described below in regard to the cooking of water-absorbing food products, it will be understood that, except for liquid absorption, the same conditions, procedures, ovens, cooking liquids, bags, cooking liquid amounts, etc. will be used in the inventive process for fully or partially cooking root vegetables.

The liquid injected or otherwise placed in the cooking bags will typically be water but can alternatively be any other liquid or combination of liquids which will be absorbed by the water-absorbing food product during the cooking process. Examples of suitable liquids for cooking various absorptive products include, but are not limited to: water; broth; wine; beer; milk; fruit juice; vegetable juice; brine; curry sauce; spice mixes; or a combination thereof.

The amount of liquid added to the cooking bags can be any amount necessary for the particular absorptive food product to achieve the degree of full cooking, the degree of partial cooking, the degree of product stickiness, the degree of product non-stickiness, and/or any other product characteristics or results required. Preferably, the amount of water and/or other liquid used will be in the range of from about 80% to about 300% by weight of the weight amount of the grain, pasta or other absorptive food product placed in the bags. More preferably, the amount of water and/or other liquid used will be in the range of from about 100% to about 250% by weight of the weight amount of the grain, pasta or other absorptive food product. Also, the amount of the water and/or other liquid absorbed by the absorptive food product during the cooking process will preferably be at least 70%, more preferably at least 90% or at least 95%, of the water and/or other liquid placed in the bag and will more preferably be substantially (i.e., at least within 1% of) 100% so that there is minimal free moisture remaining in the bag.

Along with the absorptive food product and the water and/or other cooking liquid, additional ingredients can also be added to the bag prior to sealing and cooking. Examples of additional ingredients include but are not limited to: salt; spices; flavorants; food coloring; brine solutions; vinegar; and sauces.

To provide a consistent cooking process for each bag and to prevent “nutrient flashing” from occurring when the food product and the water and/or other cooking liquid come into contact, the water and/or other cooking liquid is preferably equilibrated at a targeted reduced temperature or temperature range prior to being added to the cooking bags. By way of example, but not by way of limitation, it will be understood that the water and/or other liquid can be “equilibrated” prior to addition to the cooking bags by: cooling or heating the liquid by passing the liquid through a heat exchanger; cooling or heating the liquid using a cooling or heating element; injecting steam into the liquid; holding the liquid in a buffer vessel for a sufficient time to allow equilibration to occur; tempering the liquid in a vessel equipped with a glycol, reflective, or other cooling or heating jacket; etc.

The water and/or other liquid will preferably be equilibrated prior to use at a temperature of not more than 60° F., more preferably in the range of from about 35° F. to about 60° F., and will most preferably be equilibrated prior to use at a temperature in the range of from about 40° F. to about 50° F.

However, it will also be understood that the water and/or other liquid can alternatively be heated to a desired elevated temperature or temperature range, if desired, for hot-filling the bags.

The absorptive food product and the water and/or other cooking liquid can be placed in the cooking bags in any order desired, or simultaneously. The bags can be manually filled but will preferably be filled and sealed using a vertical form fill and seal machine. Examples of commercial vertical form fill and seal machines which are well suited for use in the inventive process are the CRYOVAC vertical form fill and seal machines available from Sealed Air of North Carolina.

The total amount of all of the ingredients placed in each of the cooking bags prior to sealing will preferably be in the range of from about ¼ lb to about 50 lb, more preferably from about ¼ lb to about 5 lb. The bags will also preferably be filled and sealed under a partial vacuum so that only from about 5% (or less) to about 20%, more preferably only from about 5% (or less) to about 10%, of the available empty volume of each filled and sealed bag will be filled with air. This allows for expansion of the product in the bag during the cooking process as the water and/or other liquid is absorbed, and also extends the shelf-life of the product.

The cooking bags used in the inventive process will preferably be “high temperature” cooking bags designed for cooking at temperatures up to 350° F. or more. Suitable bags can be formed, for example, from Mylar film or high and low density Polyethylene and will preferably be a bag material that does not shrink significantly. It will preferably have some elasticity to allow it to balloon under pressure. Examples of commercially available cooking bags suitable for use in the inventive process include, but are not limited to, 2-5 mil cook-in bags available from Multivac, Sealed Air Co., or Flavorseal Products.

The cooking bags will preferably be sized and shaped so that when they are filled, sealed and laid on oven conveyor, the bags will lay substantially flat. By “substantially flat” it is meant that (a) prior to filling the bags, the length and width of each bag will preferably be at least 15 cm×15 cm (or a diameter equivalent thereto), more preferably at least 20 cm×20 cm (standard bag sizes used, for example, can be 8″×12″, 8″×15″, 10″×12″, 12″×14″, 12″×18″, 12″×24″ or larger) and (b) when laid on the conveyor surface after being filled and sealed, the maximum vertical thickness of each bag above the conveyor surface at any point on the bag will preferably not be more than 6 cm, more preferably not more than 5 cm, more preferably not more than 4 cm, more preferably not more than 3.5 cm, more preferably not more than 3 cm, more preferably not more than 2.8 cm, and most preferably about 1 inch or less.

This controlled thin profile of the sealed cooking bags as they are conveyed through the continuous oven provides more consistent and more uniform heat transfer and liquid absorption within each bag and from bag-to-bag. The controlled thin profile of the cooking bags also allows the bags of product to be chilled much more rapidly and in a much more uniform manner after cooking. In addition, the thin profile of the bags (a) facilitates packaging and shipping, and (b) allows the bags to be easily flipped, rotated or moved during the cooking process or transferred between multiple spiral ovens operating at different temperatures.

The continuous oven used in the inventive process can be a spiral oven, a linear oven, a ROTOCHEF oven, or any other continuous oven wherein it is possible to provide and maintain a circulating vapor cooking medium in the oven in which least 30% by volume, more preferably at least 35% or from about 35% to 100% volume, of the total volume of the vapor cooking medium is superheated steam. More preferably, the vapor cooking medium in the continuous oven will comprise at least 90% by volume superheated steam and will most preferably comprise about 95% by volume superheated steam or more.

In the inventive process, because the vapor heating medium only contacts the exterior surfaces of the sealed bags as they are conveyed through the oven and does not contact the ingredients themselves, any remaining portion of the cooking medium which is not superheated steam will typically be only air. Consequently, the superheated steam circulating in the oven keeps the cooking chamber clean and no subsequent chemical cleaning is required.

The flow regime of the vapor cooking medium in the continuous oven for contacting the sealed bags can be a convective flow regime, an impingement flow regime, or a combination thereof. However, the flow regime and velocity preferably will not be sufficiently strong to displace or move the sealed bags on the conveyor or to scorch or burn the cooking bags. Also, in comparison to other processes, the cooking bags used in the inventive process are not treated in an aggressive manner or subjected to harsh conditions which could cause the bags to be punctured, or damaged in other ways, which would compromise the integrity of the bags.

The vapor cooking medium in the continuous oven will preferably be maintained at a temperature in the range of from about 190° F. to about 350° F. In order to maintain the steam content of the vapor cooking medium in a superheated state, particularly at very high steam concentrations of up to 90%, 95%, or 100%, the vapor cooking medium will preferably be maintained at a temperature which is above the boiling point temperature of water at the pressure existing inside the oven. Cooking the product using a superheated vapor cooking medium at a temperature above the boiling point significantly accelerates the rate of heat transfer through the cooking bag.

Because the inlet and/or outlet openings of the continuous oven, although preferably minimized or choked in size to the degree possible for passage of the bags, will typically be open to the atmosphere, the pressure inside the oven during the inventive cooking process will typically be at or slightly above the atmospheric pressure outside of the oven. Thus, assuming standard atmospheric pressure, the vapor cooking medium inside the oven will preferably be maintained at a temperature of greater than 212° F.

The vapor cooking medium will more preferably be maintained at a temperature of a least 215° F., more preferably from about 215° F. to about 300° F., more preferably from about 215° F. to about 250° F., more preferably from about 215° F. to about 230° F., and most preferably at about (i.e., within ±1° F. of) 220° F.

For water-absorbing food products, or root vegetables, of the type discussed herein, the residence time of the sealed cooking bags in (i.e., the time required for the bags to travel through) the cooking chamber of the continuous oven for fulling cooking the product will typically be in the range of from about 8 to about 50 minutes, more preferably from about 10 to about 45 minutes. For partially cooking some of these food products, the residence time of the sealed bags in the continuous oven can be as short as about 5 minutes.

Many cooking bag materials can deteriorate when exposed to excessive temperatures for more than a few minutes. However, an additional benefit of operating in a superheated steam environment at the more preferred and most preferred temperatures discussed above is that, when the cooking bags enter and travel through an initial portion of the oven, some water droplets from the superheated steam environment will form on the exterior of the cooking bags to keep the bags cooler during at least the initial stage of the cooking process. This in turn allows the use of higher oven temperatures to reduce cooking times.

The target temperature of the vapor cooking medium will preferably be maintained by adding superheated steam, preferably under pressure, to the vapor cooking medium. The target temperature of the vapor cooking medium will more preferably be maintained by both adding fresh superheated steam to the vapor cooking medium and heating the vapor cooking medium using one or more heating elements or burners.

Examples of heating elements preferred for use in heating the vapor cooking medium include, but are not limited to, electric heating elements, gas heating elements, and thermal fluid elements. The one or more heating elements can be included in or consist of exchangers located outside of the continuous oven but will more preferably be located inside the continuous oven either in the cooking chamber or more preferably in a separate or separated chamber or portion of the continuous oven. The heating elements will also preferably be finned heating elements.

The fresh superheated steam can be added to the vapor cooking medium in any manner including, but not limited to, injecting the superheated steam into the continuous oven at one or more locations (preferably into both the upper end and the lower end of the oven chamber in the case of a spiral oven) or injecting the superheated steam into a stream of the vapor cooking medium which is being circulated outside of the oven for heating or other purposes.

The continuous oven used in the inventive process will preferably be a spiral oven comprising a wire mesh or other open conveyor belt which will carry the sealed bags either upwardly or downwardly, preferably upwardly, through the oven chamber in a spiral pattern. Spiral ovens generally have smaller footprints and therefore require much less floor space than lengthy linear ovens of similar capacity. In addition, because of their more compact, efficient, box-like construction, spiral continuous ovens are generally better suited than elongated linear continuous ovens for creating and maintaining a high superheated vapor environment. Examples of commercial spiral ovens which are well suited for adaptation and use in the inventive process include, but are not limited to, the Micro, Mini, Medium, Large, and XL Spiral Ovens available from Unitherm Food Systems, Inc. of Bristow, Okla.

When using a continuous spiral oven in the inventive process, the spiral oven will preferably be adapted such that: (a) the pitch or angle of the conveyor belt as it spirals upwardly or downwardly in the oven chamber will preferably not be more than 2° to 4° so that the ingredients in the bags will not pool in the “lower” ends of the bags; (b) the oven fan, which performs as the circulation and contacting delivery device for the superheated vapor, delivers the superheated vapor energy to the bags such that a uniform cook occurs; (c) the oven heating elements modulate close to the setpoint so as to avoid temperature spikes in the superheated vapor; and (d) the oven controls are capable of providing and maintaining an over-fill condition of the oven with superheated steam so that some excess superheated steam will be exhausted away, thereby ensuring that a full 100% superheated steam environment can be reliably achieved.

As indicated above, the product prepared in accordance with the inventive process can also be quickly chilled in the sealed cooking bags after cooking (preferably to a chilled temperature in the range of from about 2° C. to about 6° C. and more preferably about 4° C.) and then stored in the sealed cooking bags until use (e.g., for assembling ready-to-eat meals at the same processing facility) or for shipment to other locations, ultimately for opening and use by consumers or food service institutions. Cooking the product in the bags provides a highly effective lethality step for the destruction of pathogens. Subsequently, by keeping the product in the sealed cooking bags when handling, transferring, chilling, storing, and/or shipping the cooked product, the cooking bag provides an effective barrier against cross-contamination thus providing significantly improved product safety and shelf life.

Consequently, the cooked product produced by the present invention which is aseptically retained in the sealed cooking bags will qualify as Alternative 1 or Alternative 2 under U.S.D.A. regulations and will also eliminate the need for adding any anti-microbial agents such as sodium lactate or performing other post-lethality steps.

Examples of systems suitable for chilling the cooked product in the sealed cooking bags include, but are not limited to, a Unitherm continuous chilled water bath; spiral chillers; and linear impingement chillers. The sealed bags of cooked product will preferably be chilled by a drenching water spiral or combination air and water chiller.

The following Example is presented solely for purposes of illustration and, unless expressly stated, is not intended to limit the scope of the present invention.

### EXAMPLE

Six products were successfully cooked in accordance with the present invention in 10″ by 12″ sealed cook-in bags in a Unitherm Mini Spiral Oven. The cooking recipes used for cooking the six products were as follows:

During cooking, the Unitherm Mini Spiral Oven was operated such that an amount of superheated steam was continuously exhausted from the oven inlet and discharge openings for the spiral conveyor belt to thereby maintain a 100% superheated steam cooking environment within the spiral oven.

Thus, the present invention is well adapted to carry out the objectives and attain the ends and advantages mentioned above as well as those inherent therein. While presently preferred embodiments and steps have been described for purposes of this disclosure, the invention is not limited in its application to the details of the preferred embodiments and steps. Numerous changes and modifications will be apparent to those of ordinary skill in the art. Such changes and modifications are encompassed within this invention as defined by the claims. In addition, unless expressly stated, the phraseology and terminology employed herein are for purposes of description and not limitation.

What is claimed is:

1. A method of at least partially cooking a product which absorbs water when cooked, wherein the product is selected from rice, quinoa, or other water-absorbing grains, couscous or other water-absorbing granular products, macaroni, pasta shells, or other past products, or beans, pinto beans, chickpeas, or other water-absorbing legumes, and the method comprises the steps of:
a) placing an amount of the product and an amount of liquid in each of a plurality of bags, the liquid being water, other cooking liquid, or a combination thereof;
b) sealing the bags;
c) placing the sealed bags on a conveyor which conveys the sealed bags through a continuous oven; and
d) at least partially cooking the product in the continuous oven by contacting the sealed bags with a vapor cooking medium in the continuous oven.

2. The method of claim 1 wherein the vapor cooking medium comprises at least 30% by volume superheated steam.

3. The method of claim 2 wherein the vapor cooking medium consists of air and the superheated steam or consists entirely of the superheated steam.

4. The method of claim 2 wherein during step (d) the vapor cooking medium in the continuous oven is maintained at a temperature of greater than 212° F.

5. The method of claim 4 wherein the vapor cooking medium in the continuous oven is maintained at a temperature of greater than 212° F. by adding superheated steam to the vapor cooking medium and heating the vapor cooking medium using one or more heating elements.

6. The method of claim 1 wherein the continuous oven is a spiral oven and wherein the conveyor conveys the sealed bags upwardly or downwardly in the spiral oven in a spiral pattern.

7. The method of claim 1 wherein the liquid placed in the bags in step (a) is provided for placement in the bags in step (a) at a temperature of not more than 60° F.

8. The method of claim 1 further comprising the step, prior to step (a), of equilibrating the liquid at a temperature in the range of from about 40° F. to about 50° F.

9. The method of claim 1 further comprising the step, after step (d), of cooling the at least partially cooked product by contacting the sealed bags with a cooling medium.

10. The method of claim 9 wherein the at least partially cooked product is cooled in the step of cooling by conducting the sealed bags through a chilled water bath, a spiral chiller, a drenching water spiral chiller, or a combination air and water chiller.

11. The method of claim 1 further comprising the step, after step (d), of shipping the at least partially cooked product to another location in the sealed bags.

12. The method of claim 1 further comprising the step, after step (d), of providing the at least partially cooked product to consumers or food service institutions in the sealed bags.

13. The method of claim 1 wherein the product is rice, quinoa or couscous.

14. The method of claim 1 wherein the amount of liquid placed in the bags in step (a) is in a range of from about 80% to about 300% by weight of the amount of the product placed in the bags.

15. The method of claim 14 wherein at least 70% of the amount of liquid is absorbed in step (d) by the amount of the product.

16. The method of claim 1 wherein (i) each of the bags has a size of at least 15 cm×15 cm and (ii) after filling and when placed on the conveyor, each of the bags has a maximum vertical thickness above the conveyor surface at all points on the bag of not more than 6 cm.

17. The method of claim 16 wherein the maximum vertical thickness is not more than 3 cm.

18. A method of at least partially cooking a product which absorbs water when cooked, wherein the product is selected from rice, quinoa, or other water-absorbing grains, couscous or other water-absorbing granular products, macaroni, pasta shells or other pasta products, or beans, pinto beans, chickpeas, or other water-absorbing legumes, and the method comprises the steps of:
a) placing an amount of the product and an amount of liquid in each of a plurality of bags, the liquid being water, other cooking liquid, or a combination thereof;
b) sealing the bags;
c) placing the sealed bags on a conveyor which conveys the sealed bags upwardly or downwardly in a spiral pattern in a continuous spiral oven;
d) at least partially cooking the product in the continuous spiral oven by contacting the sealed bags with a vapor cooking medium in the continuous spiral oven, the vapor cooking medium comprising at least 35% by volume superheated steam; and
e) maintaining the vapor cooking medium in the continuous spiral oven in step (d) at a temperature of greater than 212° F. by adding superheated steam to the vapor cooking medium and heating the vapor cooking medium using one or more heating elements.

19. The method of claim 18 wherein the amount of liquid placed in the bags in step (a) is in a range of from about 80% to about 300% by weight of the amount of the product placed in the bags.

20. The method of claim 19 wherein at least 95% of the amount of liquid is absorbed in step (d) by the amount of the product.

21. The method of claim 18 wherein the vapor cooking medium is heated using one or more electric, gas, or thermal fluid heating elements located in the continuous spiral oven.

22. The method of claim 18 wherein the vapor cooking medium is heated using a plurality of finned electric heating elements located in the continuous spiral oven.

23. The method of claim 18 further comprising the step, prior to step (a), of equilibrating the water at a temperature in the range of from about 40° F. to about 50° F.

24. The method of claim 18 further comprising the step, after step (d), of cooling the at least partially cooked product by contacting the sealed bags with a cooling medium.

25. The method of claim 24 wherein the at least partially cooked product is cooled in the step of cooling by conducting the sealed bags through a water chiller, a spiral chiller, a drenching water spiral chiller, or a combination air and water chiller.

26. The method of claim 18 wherein (i) each of the bags has a size of at least 15 cm×15 cm and (ii) after filling and when placed on the conveyor, each of the bags has a maximum vertical thickness above the conveyor at all points on the bag of not more than 5 cm.

27. The method of claim 26 wherein the vertical thickness is not more than 3 cm.

28. The method of claim 18 wherein the product is rice, quinoa or couscous.

29. The method of claim 18 further comprising the step, after step (d), of shipping the at least partially cooked product to another location in the sealed bags.

30. The method of claim 18 further comprising the step of providing the at least partially cooked product to consumers in the sealed bags.

31. The method of claim 18 wherein the liquid is water.

32. The method of claim 18 wherein the liquid comprises a broth.

33. The method of claim 18 wherein the liquid comprises a wine.

34. The method of claim 18 wherein the liquid comprises a beer.

35. The method of claim 18 wherein the liquid comprises a milk.

36. The method of claim 18 wherein the liquid comprises a fruit juice or a vegetable juice.

37. The method of claim 18 wherein the liquid comprises a brine solution.

38. The method of claim 18 wherein the liquid comprises a curry sauce.

39. A method of at least partially cooking a product selected from potatoes, carrots, other root vegetables, or a combination thereof, the method comprising the steps of:
a) placing an amount of the product and an amount of liquid in each of a plurality of bags, the liquid being water, other cooking liquid, or a combination thereof;
b) sealing the bags;
c) placing the sealed bags on a conveyor which conveys the sealed bags through a continuous oven; and
d) at least partially cooking the product in the continuous oven by contacting the sealed bags with a vapor cooking medium in the continuous oven.

40. The method of claim 39 wherein the vapor cooking medium comprises at least 30% by volume superheated steam.

41. The method of claim 40 wherein the continuous oven is a spiral oven and wherein the conveyor conveys the sealed bags upwardly or downwardly in the spiral oven in a spiral pattern.

42. The method of claim 41 further comprising the step, after step (d), of cooling the at least partially cooked product by contacting the sealed bags with a cooling medium.

43. The method of claim 40 wherein (i) each of the bags has a size of at least 15 cm×15 cm and (ii) after filling and when placed on the conveyor, each of the bags has a maximum vertical thickness above the conveyor surface at all points on the bag of not more than 6 cm.
